(19) United States
(12) Patent Application Publication
(10) Pub. No.: US 2004/0236439 A1
(43) Pub. Date: Nov. 25, 2004

(54) Method and device to prevent a critical operating state of a control device

(75) Inventors: Heinfried Hoffmann, Frankfurt (DE); Jorg Kiesbauer, Eppertshausen (DE)

Correspondence Address: SCHIFF HARDIN LLP, Patent Department, 6600 Sears Tower, 233 South Wacker Drive, Chicago, IL, 60606, US

(73) Assignee: Samson Aktiengesellschaft

(21) Appl. No.: 10/849,695

(22) Filed: May 20, 2004

(30) Foreign Application Priority Data
May 20, 2003 (DE) 103 23 039.4-32

(51) Int. Cl. G05B 13/02

(52) U.S. Cl. 700/79; 700/33

(57) ABSTRACT

A method and device prevent a critical operating state of a control device with a control element and an actuator, as well as an acceleration sensor and an evaluation unit. An evaluation unit input is coupled to the acceleration sensor and a further input receives external desired values for the control device. The acceleration sensor acquires acceleration measurement values for the control device, these being transmitted to the evaluation unit, with the evaluation unit deriving assessment values from these values. The evaluation unit determines internal desired values and outputs them for control of the control device. If the evaluation unit determines that the derived assessment values reach an assessment threshold indicating a control device critical operating state parameter, the evaluation unit varies the internal desired values to control the control device until the derived assessment values correspond to a predetermined assessment value indicating a control device non-critical operating state parameter.

### BACKGROUND OF THE INVENTION

The invention is in the field of the control and regulation of process systems.

To adjust and change operation parameters in process systems, control devices are frequently used that comprise a control element and an actuator to operate the control element. Regulating/controlling intervention is made via the control element in the process running in the process system. The actuator serves to operate the control element according to predetermined process parameters.

In the course of regulating or controlling processes in process systems via a control device, various operating states occur. The control device can assume an operating state which corresponds to a preliminary state of a critical operating state, or even already corresponds to a critical operating state. The critical operating state is a state of the control device that is to be prevented since, in this case, an unwanted state of the process system or of the control device exists. For example, the danger of an imminent failure, up to an at least partial destruction of the process system, can exist in the critical operating state. The operation of process systems requires that critical operating states of a control device are to be detected as far as possible in advance and then to be prevented or, in the event that a critical operating state already exists, are to be exited.

### SUMMARY OF THE INVENTION

It is the object of the invention to provide a method and device to prevent a critical operating state of a control device with which an extended protection is formed for the process system in which the control device is used.

The invention provides an acceleration sensor and an evaluation unit with a storage unit in connection with a control device which comprises a control element and an actuator, whereby an input of the evaluation unit is coupled to the acceleration sensor and the evaluation unit comprises a further input to receive external desired values for the control device. Using the acceleration sensor, acceleration measurement values are acquired for the control device, transferred to the evaluation unit, and processed in the evaluation unit in order to derive assessment values from the acceleration measurement values. Moreover, internal desired values are determined by way of the evaluation unit and output via an output of the evaluation unit for control of the control device.

For the case in which it is determined via the evaluation unit that the derived assessment values reach an assessment threshold which indicates a parameter of a critical operating state of the control device, the internal desired values to control the control device are varied by way of the evaluation unit until the derived assessment values correspond to a predetermined assessment value which indicates a parameter of a non-critical operating state. In this manner, it is possible to keep the operating state of the control device in a non-critical operating state via desired values that are internally provided by the evaluation unit.

Depending on the application, the assessment threshold can be selected such that it either indicates a preliminary stage of a critical operating state, the beginning of the critical operating state, or an initial stage during the critical operating state. In the event of the preliminary state of the critical operating state, the incidence of the critical operating state is optimally prevented via the internal desired value generation. When the critical operating state has already arrived, the internal desired value generation serves to leave the critical operating state.

Using the new method and the new device, a possibility to control and regulate control devices is achieved that can be individually tuned to different application cases in process systems in order to prevent critical operating states.

An appropriate embodiment of the invention can provide that the internal desired values are varied by way of the evaluation unit within predetermined internal desired value limits, whereby automatically processable electronic information about the internal desired value limits is stored in the storage device by the evaluation unit. The method can be adjusted to different application fields in process systems by way of the storage of the predetermined internal desired value limits in the storage device. In this manner, a continuous updating of the method is possible for a process system in which changed, predetermined internal desired value limits are made available in the storage device for the processing in the evaluation unit.

A determination of the assessment values from the acceleration measurement values that can be executed with little effort is achieved in an advantageous embodiment of the invention, in that effective acceleration measurement values are determined as assessment values.

In an embodiment of the invention, effective values of the speed can be derived for the control device from the acceleration measurement values. An acoustic signal emitted by the control device or an emitted acoustic pressure level can be determined from the effective values of the speed in order to use physical limit values for the beginning of a critical operating state based on experimental values.

In order to obtain various types of critical operating states, in particular the frequency ranges predominantly excited by the various critical operating states, and to be able to more precisely evaluate their negative effects on the behavior of the control device, an embodiment of the invention can provide that the acceleration measurement values and the assessment values are acquired for various frequency ranges.

The application possibilities of the method are expanded in an appropriate embodiment of the invention, in that the internal desired values to control the control device are output to a position controller which is coupled to the actuator and/or the control element. An adaptation of the control device to the most varied control tasks is made easier by way of the position controller.

It can appropriately be provided that a stress factor is automatically associated with the assessment values. For example, differentiation can be made between various preliminary stages or initial stages of the critical operating state by way of the automatically associated stress factor in order to adapt the internal desired value generation and output dependent on this.

An advantageous embodiment of the invention provides that binary output signals are derived from the assessment values by way of the evaluation unit and output via a further output of the evaluation unit, whereby a temporal sequence of the binary output signals is controlled dependent on the assessment values such that the temporal sequence of the binary output signals indicates the operating state of the control device. The binary output signal eases a further processing of the electronic information about the operating state of the control device, and can in particular be used as an input signal for digital circuitry.

In order to enable an adaptation to various already-existing environments in process systems, an advantageous embodiment of the invention provides that continuous output signals are derived from the assessment values by way of the evaluation unit and output by the evaluation unit.

For a preferred control of the entire process system, an embodiment of the invention provides that the binary/continuous output signals are transmitted via a communication connection to a process queue.

It can appropriately be provided that the assessment values are compared with the external desired values and an alarm notification is generated when the assessment values exceed the external desired values by a predetermined value. In this manner, a direct incorporation of the external desired values (which indicate a desired process control) is enabled.

In an embodiment of the invention to prevent a critical operating state of the control device, it can be provided that the acceleration sensor is knock sensor, for example, a low-cost knock sensor as is used in the automobile industry. In comparison with other acceleration sensors, the use of the knock sensor offers the advantage that it can be provided as a mass-produced article (low-cost) because such sensors are already used as such in large quantities in the automobile industry. However, the knock sensor possesses a sufficient precision for the detection of critical operating states because the high measurement precision of acceleration sensors is frequently not necessary for this. The implementation is robust and thus very suitable for the use in process systems.

A compact and space-saving design of the device is achieved in an appropriate embodiment of the invention, in that the evaluation unit is integrated into the position controller.

### DESCRIPTION OF THE DRAWINGS

The invention is explained in detail in the following using exemplary embodiments with reference to the Figures described below.

FIG. 1 is a schematic block representation of an arrangement with a control device;

FIG. 2 is a graph showing a continuous signal dependent on the structure-borne sound/noise;

FIG. 3 is a graph showing the dependency of a structure-borne sound level on a valve setting; and

FIG. 4 is a graph showing the dependency of a percentile distribution on a structure-borne sound level.

### DETAILED DESCRIPTION OF THE PREFERRED EMBODIMENTS

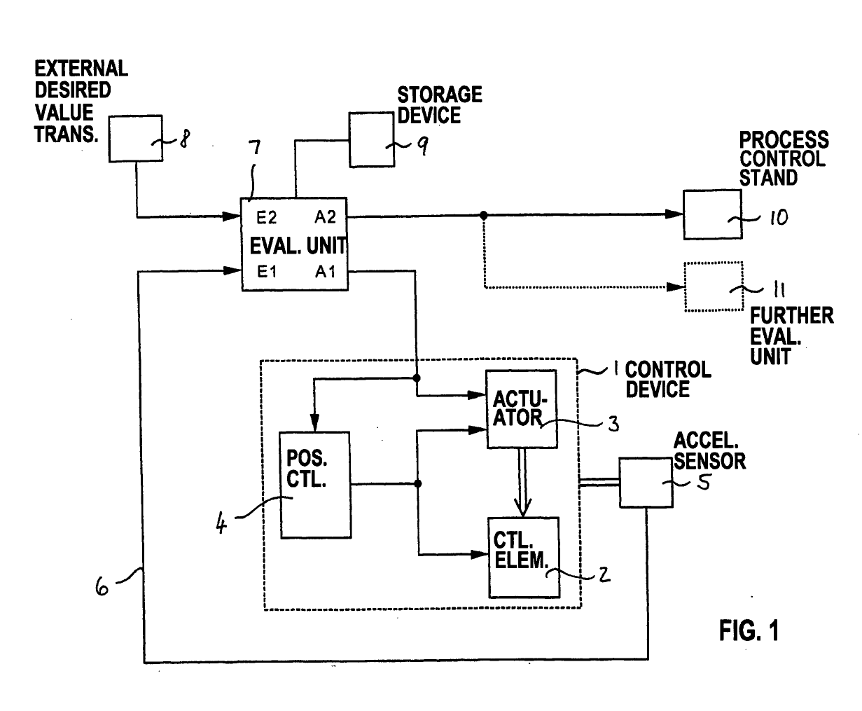

FIG. 1 schematically shows a block representation of a process system with a control device 1. The control device comprises a control element 2 whose operation serves as an intervention in a process which runs in a process system. To operate the control element 2, an actuator 3 is provided. Moreover, the control device 1 in the embodiment shown in FIG. 1 comprises a position controller 4. However, the position controller 4 is optional and can be spared in other application cases (not shown).

In the operation in the process system, acceleration values for the control device 1 are acquired via an acceleration sensor 5. The acceleration measurement values acquired by the acceleration sensor 5 are sent via a connection 6 to an input E1 of an evaluation unit 7. The evaluation unit 7 is, for example, suitable circuitry (for example, a microprocessor) for electronic processing of the acceleration measurement values. In a variation from the embodiment shown in FIG. 1, the evaluation unit 7 can be integrated into the position controller 4 in order to support an optimally compact design. The evaluation unit 7 receives external desired values from a desired value transmitter 8 via a further input E2. The external desired values correspond to a control specification for the control device 1 in the process system.

Starting from the acceleration measurement values obtained via the input E1, assessment values are determined in the evaluation unit 7. The assessment values can, for example, be effective values for the speed of the control device 1. Both the acceleration measurement values and the assessment values can be determined for various frequency ranges, meaning for various oscillation ranges of the control device 1.

The determined assessment values are compared with a comparator in the evaluation unit 7 with an assessment threshold which indicates a parameter for a critical operating state of the control device 1, and is appropriately stored in electronic form in a storage device 9 connected with the evaluation unit 7. The assessment threshold characterizes a preliminary stage, the beginning or an initial stage of the critical operating state of the control device 1. When, by way of the evaluation unit 7, it is established that the derived assessment values reach the assessment threshold, internal desired values are generated by the evaluation unit 7. The internal desired values are generated within desired value limits that are likewise stored in electronic form in the storage device 9. The generated internal desired values are then output via an output A1 of the evaluation unit 7 to the actuator 3 and/or to the position controller 4 in order to regulate the control device 1.

The regulation of the control device 1 dependent on the internal desired values leads thereunto that changed acceleration measurement values are acquired with the acceleration sensor 5 (which, for example, can be fashioned as a knock sensor) and transmitted to the evaluation unit 7 via the connection 6. The changed acceleration measurement values serve in turn for the determination of (changed) assessment values which are then compared with the assessment threshold. The internal desired values to control the control device 1 are varied by way of the evaluation unit 7 until the derived assessment values correspond with a predetermined assessment value which indicates a parameter of a non-critical operating state of the control device 1. In this manner, a critical operating state of the control device 1 is prevented from the outset when the assessment threshold indicates a preliminary stage of the critical operating state of the control device 1. In the event that the assessment value indicates the beginning or the initial stage of the critical operating state of the control device 1, variation of the internal desired value can cause the control device 1 to again leave the critical operating state.

The evaluation unit 7 can furthermore be used for this to generate a binary or a continuous output signal dependent on the acceleration measurement values/assessment values, and to transmit this signal to a process queue 10 and/or a further evaluation unit 11 via an output A2. In this manner, it is possible to follow up the information about the beginning or the course of a critical operating state of the control device 1 in the process queue 10, for example, in that an alarm notification is generated and transmitted to the process queue 10 by way of the evaluation unit 7. The further evaluation unit 11 can be used in order to process the binary/continuous output signal for further control/regulation purposes.

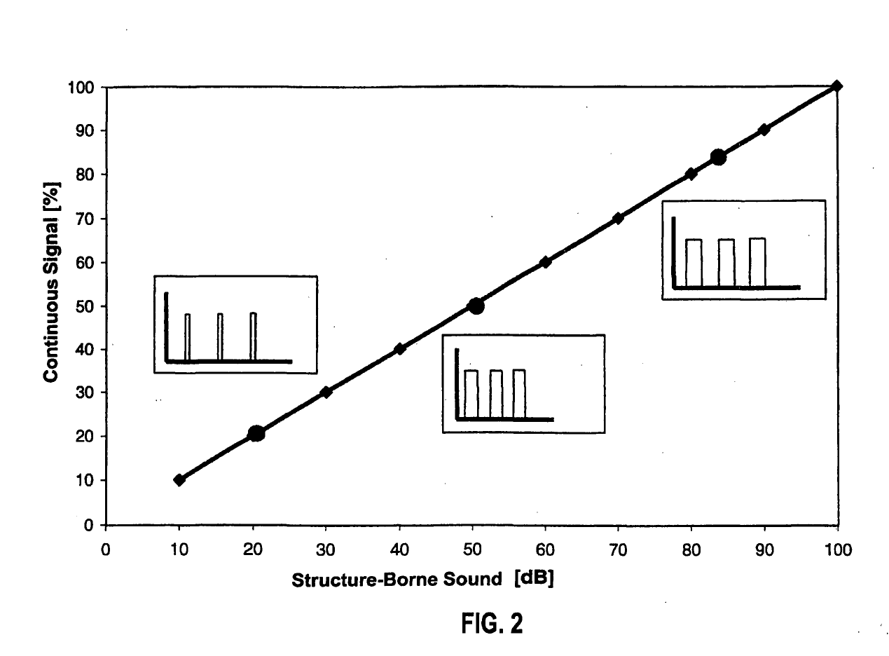

FIG. 2 shows a graphical representation of a continuous output signal dependent on structure-borne sound. The structure-borne sound is acquired as a measurement quantity with the aid of the acceleration sensor 5. Starting from the acquired structure-borne sound measurement values, a continuous output signal which, for example, has the curve shown in FIG. 2 can be generated via the summation of the acquired measurement values.

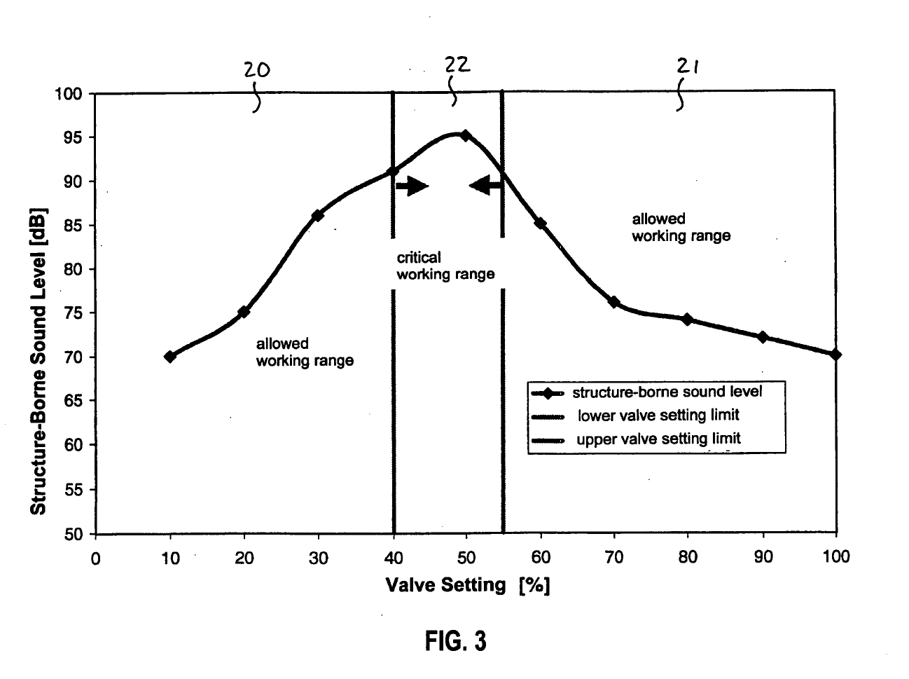

FIG. 3 shows a graphical representation of a structure-borne sound level dependent on the valve setting/position. The valve setting is a setting that characterizes the state of the control element 2. The range of the possible valve settings, which extends in FIG. 3 from 0 to 100% (which corresponds to a range between an output setting and a final condition of the control device) is divided into allowed working ranges 20, 21 and a critical working range 22. Dependent on which structure-borne sound level is acquired by way of the acceleration sensor 5, it can be decided in the evaluation of the measurement values whether an allowed or a critical working range or, respectively, operating state of the control device 1 exists. The internal desired value regulation is then initiated and/or changed with the aid of the evaluation unit 7.

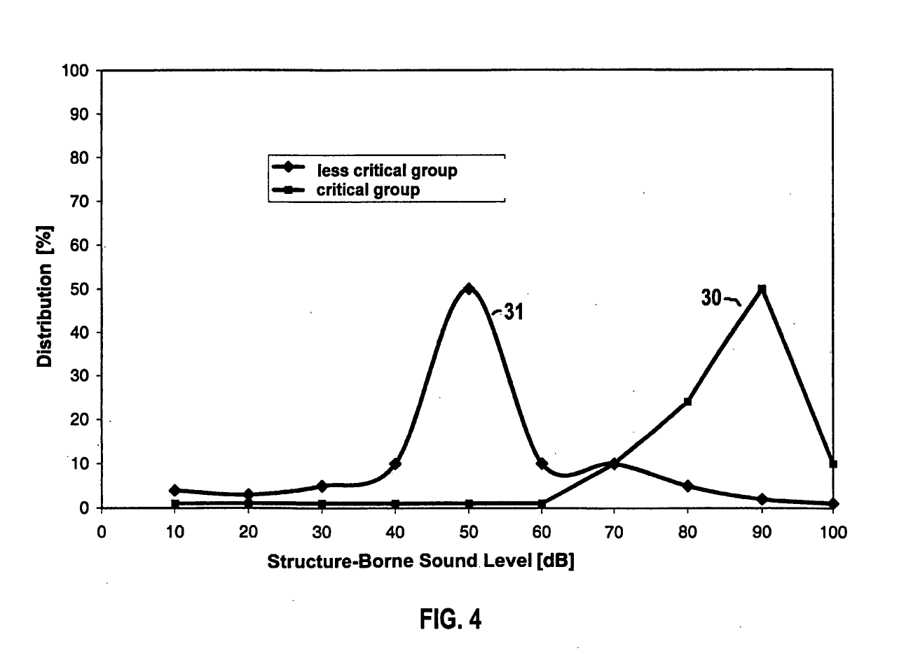

FIG. 4 shows a graphical representation of a percentile distribution dependent on the structure-borne sound level. A critical group of acceleration measurement values 30 and a less critical group of acceleration measurement values 31 are shown. When the percentile distribution of the acquired acceleration measurement values (meaning the acquired structure-borne sound level) lies around a range of 50 dB, the operating state of the control device 1 is not critical, or is critical only to a slight extent. When, however, approximately 50% of the acquired acceleration measurement values are in a range of 90 dB, it can be assumed that a critical operating state exists.

The features of the invention disclosed in the preceding specification, the claims and the drawing can be of importance both in individually and in arbitrary combination for the realization of the invention in its various embodiments.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method to prevent or avoid a critical operating state of a control device with a control element and an actuator, as well as a acceleration sensor and an evaluation unit with a storage device, wherein one input of the evaluation unit is coupled to the acceleration sensor and the evaluation unit comprises a further input to receive external desired values for the control device, the method comprising:
acquiring acceleration measurement values for the control device with the acceleration sensor;
transmitting the acceleration measurement values to the evaluation unit;
processing the acceleration measurement values by the evaluation unit thereby deriving assessment values from the acceleration measurement values;
determining internal desired values with the evaluation unit, and outputting the internal desired values via an output of the evaluation unit for control of the control device; and
if the evaluation unit determines that the derived assessment values reach an assessment threshold that indicates a parameter of a critical operating state of the control device, then
varying the internal desired values to control the control device with the evaluation unit until the derived assessment values correspond to a predetermined assessment value which indicates a parameter of a non-critical operating state of the control device.

2. The method according to claim 1, further comprising:
varying the internal desired values with the evaluation unit within predetermined internal desired value limits, wherein in the storage device
electronic information about the internal desired value limits being automatically processable by the evaluation unit are stored.

3. The method according to claim 1, further comprising:
determining effective acceleration values as assessment values.

4. The method according to claim 1, further comprising:
deriving effective values of speed for the control device from the acceleration measurement values.

5. The method according to claim 1, wherein the acceleration measurement values and the assessment values are acquired for various frequency ranges.

6. The method according to claim 1, further comprising:
outputting the internal desired values to control the control device to a position controller which is coupled to at least one of the actuator and the control element.

7. The method according to claim 1, further comprising:
automatically associating a stress factor with the assessment values.

8. The method according to claim 1, further comprising:
deriving binary output signals from the assessment values with the evaluation unit; and
outputting the binary output signals via a further output of the evaluation unit, a temporal sequence of the binary output signals being controlled dependent on the assessment values such that the temporal sequence of the binary output signals indicates an operating state of the control device.

9. The method according to claim 1, further comprising:
continuously deriving output signals from the assessment values with the evaluation unit and;
outputting the continuously derived output signals by the evaluation unit.

10. The method according to claim 8, further comprising:
transmitting the binary output signals to a process control stand via a communication connection.

11. The method according to claim 9, further comprising:
transmitting the continuous output signals to a process control stand via a communication connection.

12. The method according to claim 1, further comprising:
comparing the assessment values with the external desired values; and
generating an alarm notification when the assessment values exceed the external desired values by a predetermined value.

13. A device to prevent or avoid a critical operating state of a control device comprising a control element and an actuator, the device comprising:
an acceleration sensor configured to acquire acceleration measurement values of the control device;
an evaluation unit comprising:
a first input that is coupled to the acceleration sensor to transfer the acceleration measurement values;
a further input to receive external desired values for the control device;
a processor configured to process the acceleration measurement values in order to derive assessment values from the acceleration measurement values, and to generate internal desired values;
an output at which the internal desired values are output to control the control device; and
a comparator configured to compare the derived assessment values with an assessment threshold in order to, in the event that it is established that the derived assessment values reach the assessment threshold which indicates a parameter of a critical operating state of the control device, vary, with the evaluation unit, the internal desired values to control the control device, until the derived assessment value corresponds to a predetermined assessment value which indicates a parameter of a non-critical operating state of the control device;
the device further comprising
a storage device coupled to the evaluation unit;

14. The device according to claim 13, wherein the control device further comprises:
a position controller, coupled to at least one of the actuator and the control element, which receives the internal desired values to control the control device.

15. The device according to claim 13, wherein the acceleration sensor is a knock sensor.

16. The device according to claim 14, wherein the evaluation unit is integrated into the position controller.

17. The device according to claim 15, wherein the evaluation unit is integrated into the position controller.
